(19) United States
(12) Patent Application Publication
(10) Pub. No.: US 2023/0191937 A1
(43) Pub. Date: Jun. 22, 2023

(54) Charging Station for Electric Vehicles

(71) Applicant: Juice Technology AG, Cham (CH)

(72) Inventor: Christoph ERNI, Winkel (CH)

(73) Assignee: Juice Technology AG, Cham (CH)

(21) Appl. No.: 17/923,501

(22) PCT Filed: Apr. 30, 2021
(86) PCT No.: PCT/EP2021/061429

§ 371 Date: Nov. 4, 2022

(30) Foreign Application Priority Data
May 15, 2020 (DE) 10 2020 113 235.2

(51) Int. Cl. B60L 53/63; H02J 1/14; H02J 7/00; B60L 53/14; B60L 53/66; H01M 10/44

(52) U.S. Cl. CPC B60L 53/63; H02J 1/14; H02J 7/0013; H02J 7/00712; B60L 53/14; B60L 53/66; H01M 10/44; H02J 2310/52; H02J 2310/48; H01M 2220/20; H04L 12/10

(57) ABSTRACT

An apparatus for charging electric vehicles is provided having a connection to a power supply grid, at least one charging connection for at least one electric vehicle, and a central processing unit, wherein the apparatus further comprises a receiver device designed as a ripple control receiver and configured to receive a low-frequency ripple control signal from a ripple control transmitter in the power supply grid, and a relay element configured to process a control signal from the receiver device and to pass it on to the central processing unit, wherein the central processing unit is configured to selectively reduce the charging current of an electric vehicle connected to the at least one charging connection within a predetermined period of time.

### CROSS-REFERENCE TO RELATED APPLICATION

The present application is a U.S. national phase entry of pending International Patent Application No. PCT/EP2021/061429, international filing date Apr. 30, 2021, which claims priority to German Patent Application No. DE 10 2020 113 235.2, filed May 15, 2020, the contents of which are incorporated by reference in their entireties.

### FIELD OF THE INVENTION

The present invention relates to an apparatus for charging electric vehicles according to the preamble of claim 1.

With electric vehicles or hybrid vehicles becoming more and more prevalent in the motor vehicle market worldwide, the technical demands imposed on the operators of power supply grids and in particular of public or private charging stations are also increasing. Power supply grids or electricity supply grids are delicate structures which serve to supply the consumer with electrical energy and in this case connect power plants and other energy converters to each other. Attempts are made to lower grid losses by closely monitoring supply and demand, wherein the grid frequency of 50 Hz in Europe is observed at a grid voltage of 230 V.

Given the limited resources of the energy supply companies, in order to allow efficient load management, more and more energy utility companies are calling for the possibility of uncoupling charging stations of electric vehicles or even individual plug sockets dedicated to electric vehicles from the power supply grid. This process is also referred to as load shedding.

A possibility of disconnecting and connecting specific electrical consumers such as, e.g., electrical boiler systems or photovoltaic systems, constitutes the so-called ripple control technique which involves remote control via the existing power supply grid. In this case, control signals are transmitted via the power grid exclusively from a central ripple control transmitter to decentralized ripple control receivers. The control commands are transmitted by pulse sequences in the low frequency range which are superimposed on the normal grid voltage with a predetermined amplitude, wherein a pulse telegram results through the transmission of specific codes.

Such a sudden disconnecting of charging stations and/or plug sockets under full load by means of the above-mentioned ripple control technique would lead, in the case of the relatively high currents which are required for charging electric vehicles, to dangerous electric arcs in the mechanical switching elements and consequently possibly to damage to the conductor contacts or other components in the charging stations or even in the electric vehicles themselves.

### OBJECTS OF THE INVENTION

It is therefore the object of the present invention to provide an apparatus for charging electric vehicles which at least partially overcomes the above-mentioned disadvantages and allows load shedding that is as free from damage as possible, controlled and substantially risk-free and allows optimized load management when charging electric vehicles.

This object is achieved by the subject matter of claim 1. Advantageous embodiments are described in the dependent claims.

### SUMMARY OF THE INVENTION

According to the invention, provision is made for an apparatus for charging electric vehicles having a connection to a power supply grid, at least one charging connection for at least one electric vehicle, a central processing unit, a receiver device designed as a ripple control receiver and configured to receive a low-frequency ripple control signal from a ripple control transmitter in a power supply grid, and a relay element configured to process a control signal from the receiver device and to pass it on to the central processing unit, wherein the central processing unit is configured to selectively reduce the charging current of an electric vehicle connected to the at least one charging connection within a predetermined period of time. A particularly careful, controlled, load-free and thus optimized disconnecting of the electric vehicles to be charged or taking of said vehicles off the grid is thus possible. By dispensing with the sudden shedding, it can be signalled to the electric vehicles specifically and carefully that they can now initiate internal measures associated with reducing or disconnecting the charging current. Furthermore, costs can be reduced by using proven signalling technologies. A special installation of additional communication devices is thus not required.

Advantageously, the reducing of the charging current takes place differently for each electric vehicle connected to the at least one charging connection. A cascade-like shutting down of the charging stations is thus made possible, further reducing the danger of damage. In this case, in the context of optimized load management, consideration can be taken in particular of the different existing charging currents.

Particularly advantageously, the relay element is a solid-state relay. Compared to electromechanical relays (EMRs), solid-state relays (SSRs) have the advantage that they are smaller, the result of which is a considerable space saving on printed circuit boards, that they have better system reliability due to the lack of moving components, that they place no demands on the control electronics and switch bounce-free and in particular that they have lower output voltages. For example, this is because only voltages of greater than 10 V can be reliably connected to electromechanical relays.

Further advantageously, the central processing unit is a microcontroller. Components of this type are flexibly programmable, widely available and inexpensive.

The receiver device preferably provides a potential-free contact which clearly indicates a positive or negative signalling, i.e. whether yes or no, whether 0 or 1. The receiver device may furthermore be a ripple control receiver which is additionally configured to receive a wired control signal via a line network in accordance with a carrier-frequency technology such as Powerline Communication (PLC), or which is additionally or alternatively configured to receive a wireless control signal via a radio network. The control signal can be, for example, a low-frequency ripple control signal in the frequency range of 110 Hz to about 2000 Hz in the power supply grid. In this frequency range there exists a multiplicity of predetermined pulse sequences which, for example, are present in corresponding libraries and are available in most energy supply companies.

Furthermore, it is preferred that an output signal from the relay element does not exceed a voltage of 3.5 V. For controlling semiconductor components such as the preferred microcontroller with the customary control voltages of 3 V, no further components are therefore necessary, as a result of which the costs for the apparatus can be kept low.

Advantageously, the central processing unit is designed to be physically separate from the at least one charging connection and/or the at least one charging connection is designed as a wall box. There is thus no need for each individual charging station or each individual charging socket to have its own central processing unit, rather it is sufficient to have one central processing unit per building which is responsible for the power management of all connected energy consumers and energy producers. An illustrative example of this is a multi-storey car park or underground car park having a plurality of charging stations for a corresponding number of electric vehicles as power consumers and optionally a photovoltaic system present on the roof.

Advantageously, the apparatus is configured to reduce the charging current at each charging connection to zero in ordered fashion within the predetermined period of time. The complete reduction corresponds to a controlled load shedding but it is also possible to step down the charging current to a predetermined residual charging current depending on the demand on the load management. By virtue of the complete reduction of the charging current to zero, a careful, load-free disconnecting of the electric vehicles from the power supply grid is possible. Damage to the contact and switching elements involved is thus largely prevented.

The task of the load management can in particular then be undertaken by the apparatus according to the invention if the central processing unit is configured to control further power consumers and/or power producers. The apparatus according to the invention is thus able, for example, to also step down boiler systems or photovoltaic systems in a controlled manner or even take them off the power grid.

### BRIEF DESCRIPTION OF THE DRAWINGS

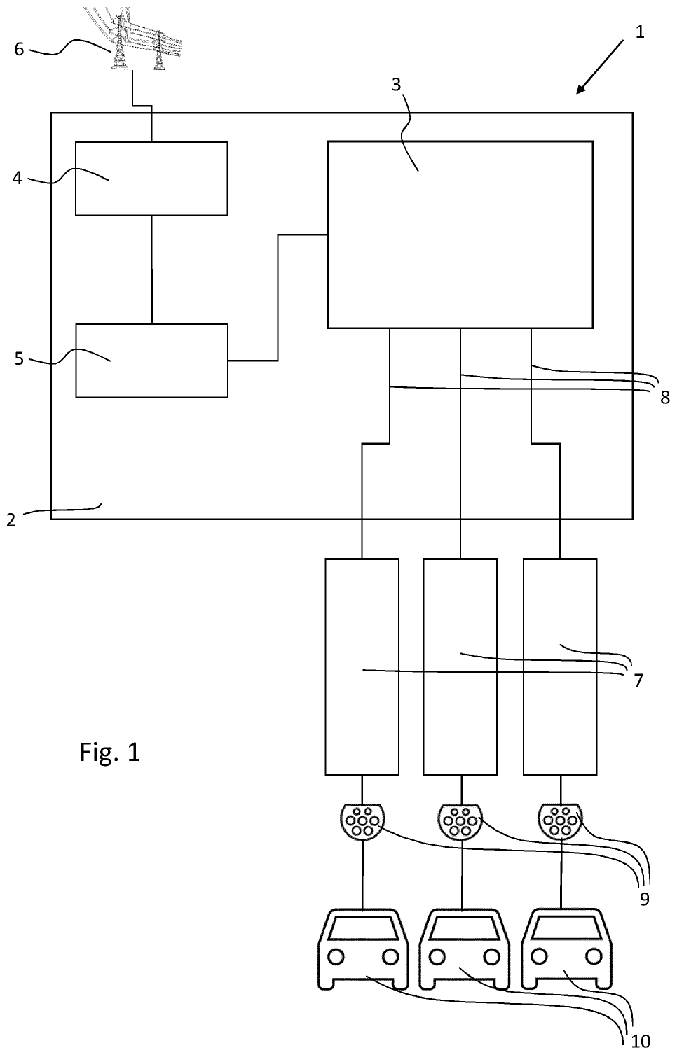

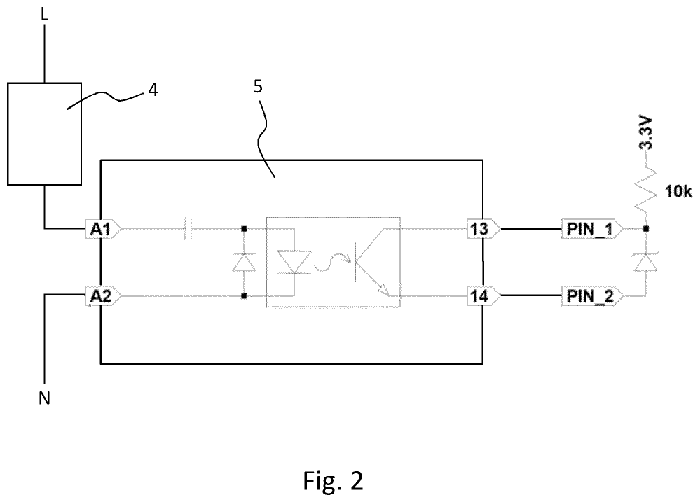

Further properties and advantages of the present invention will become apparent from the appended figures of exemplary embodiments, in which FIG. 1 shows a schematic illustration of a preferred embodiment of the apparatus according to the invention and FIG. 2 shows a detailed section of the illustration according to FIG. 1.

### DETAILED DESCRIPTION OF THE DRAWINGS

FIG. 1 schematically shows the apparatus according to the invention for charging electric vehicles in a preferred embodiment. The apparatus 1 comprises a housing 2, in which are arranged a central processing unit 3 designed as a microcontroller in the illustrated embodiment, a receiver device designed as a ripple control receiver 4, and a relay element 5 designed as a solid-state relay here. Furthermore, the apparatus 1 comprises a plurality of charging connections 7 (here three charging connections) arranged outside the housing 2. In the embodiment illustrated here, the charging connections 7 are designed as wall boxes which each have “type 2” connectors 9 for connection to an electric vehicle 10. It is understood that the charging connections 7 can also be arranged inside the housing 2. This will in particular be the case when the apparatus according to the invention is located in the garage of a family house as an individual installation having a charging connection for only one electric vehicle. However, the embodiment illustrated here is based on the example of a multi-storey car park or underground car park which has a charging station with a large plurality of charging connections 7 for charging up a corresponding number of electric vehicles 10.

The ripple control receiver 4 is connected to the power supply grid 6 of a utility company which has a ripple control transmitter (not illustrated) which emits a low-frequency ripple control signal for controlling the power supply grid 6. The ripple control receiver 4 derives the control information from the ripple control transmitter by filtering the ripple control signal sent as a pulse telegram and outputs a control signal. Alternatively or additionally, the receiver device can also be a carrier-frequency device which receives, for example, a PLC signal via the power grid and outputs a control signal at a potential-free contact. It is likewise possible that the receiver device receives the signal externally via a radio network such as, e.g., 4G, LTE, 5G, WLAN or the like.

Arranged between the receiver device 4 and the central processing unit 3 is the relay element 5 which is configured as a solid-state relay in the embodiment illustrated here. The relay element 5 processes the control signal output from the receiver device 4 and in turn signals to the central processing unit 3 that the charging current for the electric vehicles 10 connected to the corresponding charging connections 7 is to be reduced. The control signal from the receiver device 4 can contain different pulse sequences or codes, not only the code for the immediate load shedding, that is to say the shutting down or disconnecting of all the charging processes, but for reducing or increasing the drawn power to a determined value, for example. For this purpose, in the preferred embodiment illustrated here, the ripple control transmitter can emit different signals at various frequencies from the power supply grid 6, which signals are defined in a corresponding library and are correspondingly evaluated, after filtering by the ripple control receiver 4, as pulse sequences in the relay element 5 and are suitably forwarded to the central processing unit.

In the embodiment illustrated here, described by way of example is the application in which the ripple control transmitter emits the signal for the immediate load shedding of all the connected consumers. This signal is output via the potential-free contact at the output of the ripple control receiver, i.e. either the full supply signal is present and thus the normal charging is indicated, or no signal is present and thus it is indicated that the charging is not (no longer) allowed and all the charging connections should be correspondingly reduced to zero.

In the central processing unit 3 designed as a microcontroller, the exemplary signal for the immediate load shedding is processed in such a way that the outputs or lines 8 to the charging connections 7 are now allocated corresponding signals, as a result of which each charging current per charging connection 7 is reduced to zero within a determined period of time, e.g. within 10 seconds. Controlled load shedding is thus ensured because in the wall boxes 7 or charging connectors no electric arcs occur at the mechanical switches or contacts and damage to the components is thus avoided.

FIG. 2 shows a section of the illustration from FIG. 1, wherein the ripple control receiver 4, the relay element 5 and the connection to the central processing unit 3 are depicted in more detail. The ripple control receiver 4 functions as a type of switch which, at its potential-free outputs, outputs the pulse sequence of the ripple control signal, in the present case that is to say a full signal or zero. A1 and A2 are inputs of the solid-state relay 5 which, in the embodiment illustrated here, is a product from Omron with the designation G3RV-SR500-D AC230. The identifier D AC230 in the product designation indicates that a DC output at an AC input voltage of up to 230 V is involved. The full 230 V AC signal from the ripple control receiver 4 is consequently present at the relay contact A1; the neutral conductor is connected at the input A2.

Electronic components are illustrated within the relay element 5, wherein the ones depicted here form only a symbolic selection. FIG. 2 merely shows the outputs 13 and 14 of the solid-state relay 5 that are significant here, which outputs are connected to the logic input of the microcontroller or of the central processing unit, represented by PIN_1 and PIN_2. The following switching logic thus results for the exemplary load shedding:

| | | | Charging current at |
|---|---|---|---|
| Voltage at A1/A2: | Input processing unit: | | charging connection: |
| 230 VAC | 0 | V | yes |
| 0 VAC | 3.3 | V | no |

This 0/1 decision for the load shedding can also be implemented with another programming in the central processing unit 3, i.e. the invention is not limited to the exemplary embodiment illustrated here. For example, more than one logic input of the microcontroller can be connected. Other signal sequences can thus, as output signal from the receiver device 4, reach the central processing unit 3 via the relay element 5 and be processed in said processing unit, e.g. a load halving, a restart, a uniform starting-up of charging currents each with different periods of time or the like.

As an alternative to the solid-state relay 5 from Omron used in the preferred embodiment, other similar semiconductor components can also be used in order to evaluate the signals from the receiver device 4 and to forward corresponding control signals to the central processing unit 3.

The charging connections 7 which, in the embodiment illustrated here, are connected via the lines 8 to the central processing unit 3 are controlled by the latter in such a way that they step down the charging current for the attached electric vehicles 10 to zero in ordered fashion for approximately ten seconds and subsequently open the relay contacts of the three phases and of the zero conductor. As a result, the occurrence of an electric arc, such as during the sudden disconnection, is avoided, e.g. by way of a contactor. The mechanical contacts of the charging connections 7 or of the connected electric vehicles thus suffer no damage.

With the subject matter of the invention, provision was made for an apparatus for charging electric vehicles which allows load shedding which is free from damage, controlled and substantially risk-free and thus allows optimized load management when charging electric vehicles.

1-11. (canceled)

12. Apparatus for charging electric vehicles, the apparatus having a connection to a power supply grid, at least one charging connection for at least one electric vehicle, and a central processing unit, the apparatus further comprising:
a ripple control receiver configured to receive a low-frequency ripple control signal from a ripple control transmitter in a power supply grid;
a relay element configured to process a control signal from the receiver and to pass it on to the central processing unit; and
the central processing unit is configured to selectively reduce the charging current of an electric vehicle connected to the at least one charging connection within a predetermined period of time.

13. The apparatus of claim 12 wherein the reducing of the charging current is different for each electric vehicle connected to the at least one charging connection.

14. The apparatus of claim 13 wherein the relay element is a solid-state relay.

15. The apparatus of claim 14 wherein the central processing unit is a microcontroller.

16. The apparatus of claim 15 wherein the central processing unit is physically separate from the at least one charging connection and the at least on charging connection is configured as a wall box.

17. The apparatus of claim 16 wherein the receiver is configured to receive a wired control signal via a line network in accordance with a carrier-frequency technology such as Powerline Communication.

18. The apparatus of claim 16 wherein the receiver is configured to receive a wireless control signal via a radio network.

19. The apparatus of claim 16 wherein the receiver receives a low-frequency ripple control signal in the frequency range of 110 Hz to about 2000 Hz from the power supply grid.

20. The apparatus of claim 16 wherein an output signal from the relay element does not exceed a voltage of 3.5 V.

21. The apparatus of claim 16 configured to reduce the charging current at each charging connection to zero in ordered fashion within the predetermined period of time.

22. The apparatus of claim 16 wherein the central processing unit is configured to control further power sources and power consumers.

23. The apparatus of claim 12 wherein the relay element is a solid-state relay.

24. The apparatus of claim 12 wherein the central processing unit is a microcontroller.

25. The apparatus of claim 12 wherein the receiver is configured to receive a wired control signal via a line network in accordance with a carrier-frequency technology such as Powerline Communication.

26. The apparatus of claim 12 wherein the receiver is configured to receive a wireless control signal via a radio network.

27. The apparatus of claim 12 wherein the receiver receives a low-frequency ripple control signal in the frequency range of 110 Hz to about 2000 Hz from the power supply grid.

28. The apparatus of claim 12 wherein the central processing unit is physically separate from the at least one charging connection.

29. The apparatus of claim 28 wherein the at least one charging connection is configured as a wall box.

30. The apparatus of claim 12 wherein the central processing unit is configured to control further power sources and power consumers.

31. The apparatus of claim 12 configured to reduce the charging current at each charging connection to zero in ordered fashion within the predetermined period of time.

32. The apparatus of claim 12 wherein the at least one charging connection is configured as a wall box.
